(19) United States
(12) Patent Application Publication
(10) Pub. No.: US 2014/0318049 A1
(43) Pub. Date: Oct. 30, 2014

(54) CONNECTOR FOR HOLLOW PORTIONS OF PROFILE MEMBER(S), PARTICULARLY FOR DOUBLE-PANE WINDOW FRAMES

(71) Applicants: Jérôme Paquet, Treffort (FR); Olivier Bizzini, Saint Egreve (FR)

(72) Inventors: Jérôme Paquet, Treffort (FR); Olivier Bizzini, Saint Egreve (FR)

(73) Assignee: A. RAYMOND ET CIE, Grenoble (FR)

(21) Appl. No.: 14/006,209

(22) PCT Filed: Mar. 30, 2012
(86) PCT No.: PCT/EP12/55888

§ 371 Date: Sep. 28, 2013

(30) Foreign Application Priority Data
Apr. 14, 2011 (FR) 115326

(51) Int. Cl. E06B 3/24; E06B 3/64; E06B 7/12; F16B 7/04

(52) U.S. Cl. CPC E06B 3/24; F16B 7/0446; E06B 3/64; E06B 7/12
USPC 52/204.593; 403/403

(57) ABSTRACT

The invention relates to a connector for hollow portions of profile member(s), comprising two bars connected by a contact pad and intended to be inserted into the free ends of the hollow portions of profile member(s), each bar being provided with anchoring blades arranged so as to engage with the profile member(s) so as to mechanically attach the latter to the connector, and sealing blades arranged so as to engage with the profile member(s) in order to form a damp-proof course in the profile member(s). The invention also relates to a double-pane window, the frame of which consists of hollow portions of profile member(s) connected together by such a connector.

### CROSS-REFERENCE TO RELATED APPLICATION

This application is a U.S. National Phase Patent Application based on International Application No. PCT/EP2012/055888 filed Mar. 30, 2012, which claims priority to French Patent Application No. 1153226 filed Apr. 14, 2011, the entire disclosures of which are hereby explicitly incorporated by reference herein.

### BACKGROUND OF THE INVENTION

1. Field of the Invention.

The present invention relates to a connector for hollow portions of profile member(s). The invention also concerns a double-pane window comprising at least two substantially parallel glass panes separated by a frame formed of at least two hollow portions of profile member(s) joined by such a connector.

2. Description of the Related Art.

In a known manner, double-pane and triple-pane windows are formed of glass panes spaced apart by a metal or synthetic frame that is adhesively bonded to the glass panes, for example with butyl cord. The glass panes are separated by a layer of gas such as, for example, air, argon, which improves the insulating power of double-pane and triple-pane windows. The resultant glazing is integrated into the posts of a window or French window. For the sake of convenience, the term double-pane window will be used below to denote any type of window having a similar structure with several panes of glass, regardless of the number of panes.

The frame is, for example, constructed of a single hollow profile member, bent to form the corners and sides of the frame. The hollow portions of the profile member, which are located at the ends of the profile member, are placed in alignment with one another and can be connected together by a connector that engages respectively in each hollow portion of a profile member. In this configuration, the connector has a straight general shape and comprises two bars disposed in alignment with each other, separated by an alignment pad having a cross section larger than those of the bars and against the bearing surfaces of which the ends of the profile member come to bear. Bending the profile member at the corners is a difficult operation, and this embodiment generates a large number of rejects.

The frame can also be constructed of straight segments of profile members, joined two by two by corner connectors defining the corners of the frame. Each connector has a general V shape, with the bars oriented at right angles to each other and inserted in the hollow portions of the profile members. As in the preceding embodiment, the two bars are separated by a pad, here a corner pad, having a cross section larger than those of the bars and against the bearing surfaces of which the ends of the profile member come to bear.

The spacer is intended to delimit a frame of smaller dimensions than the contours of the glass panes. Thus, the glass panes and the frame define a channel in which a putty, for example made of polyurethane, polystyrene or silicone, can be placed. This putty secures the glass panes, the profile members and the connectors to one another. The putty further ensures that the layer of gas trapped between the glass panes and the spacer is sealed against water and water vapor. In addition, a desiccant material, for example in the form of granules, is generally provided in the profile members to absorb the moisture present in the gas layer during the manufacture of the double-pane window. To allow moisture to pass from the gas layer to the interior of the profile members, the latter can be provided with aligned perforations of reduced dimensions, which permit the passage of gas, but not of granules of desiccant material.

Examples of connectors are given in particular by the publications EP 1 914 373, FR 2 659 108 and FR 2 604 210, which describe corner connectors whose bars are provided with anchoring fins extending laterally from the cores of the bars and adapted to cooperate with the respective interiors of the profile members in order to secure them to the corner connectors. In publication EP 1 914 373, the corner connector is coupled to an additional part in the form of a wedge that is slid into the seat separating two successive fins. When the connector is fitted into the end of the profile member, the anchoring fins deform elastically and the wedge forms a packing The wedge thus keeps the desiccant granules from escaping from the spacer. This solution is not very reliable and is hard to implement. There is a risk that the wedges will come out of their seats as the connectors are being inserted in the profile members. The presence of the wedges thus makes the connectors hard to manipulate. In addition, the wedges are additional parts, representing an additional production cost. Moreover, the connectors of publications FR 2 659 108 and FR 2 604 210 are provided with anchoring fins that cause high mechanical stress at the ends of the profile members, thus potentially damaging or even breaking them. These solutions, therefore, are not satisfactory.

### SUMMARY OF THE INVENTION

The present invention provides a connector for hollow portions of profile members, the connector including two longitudinal bars joined together by a pad and intended to be inserted respectively in the hollow portions of profile member(s), each bar being provided with at least one laterally-extending transverse anchoring fin arranged to cooperate with the inner face of the corresponding hollow portion of profile member(s) in order to mechanically attach the connector to the profile member.

The object of the invention is to remedy the disadvantages of the prior art by proposing an easy-to-manufacture connector for hollow portions of profile member(s), particularly for double-pane windows, that permits effective anchoring of the connector in the profile member(s) without any risk of damaging it or them, requires only low mounting force, ensures that the desiccant granules disposed in the profile member(s) do not escape therefrom, limits the impact of thermal dispersion and facilitates the installation of frames for double-pane windows.

To this end, the invention concerns a connector for hollow portions of profile member(s), the connector including two longitudinal bars joined together by a pad and designed to be inserted respectively in the hollow portions of profile member(s), each bar being provided with at least one transverse anchoring fin extending laterally and arranged to cooperate with the inner face of the corresponding hollow portion of a profile member in order to mechanically attach the connector to the profile member, wherein each bar is also provided with at least one transverse sealing fin extending laterally and arranged to cooperate with the inner face of the hollow portion of a profile member in order to form a sealing barrier in the profile member.

The term “hollow portion of a profile member” signifies here, with reference to a single profile member, that at least its two ends are hollow, each hollow end being adapted to receive one of the bars. The two free ends of the single profile member are therefore connected to each other by a single connector. With reference to a plurality of profile members that are connected together, “hollow portion of a profile member” here means that each profile member has at least one hollow end in which a bar can be inserted. The profile members are thus connected two by two, by one connector or by a plurality of connectors. It is well understood that the profile member(s) can also be hollow over their entire length.

The connector according to the invention is therefore easy to manufacture and use. It provides effective anchoring by virtue of the anchoring fin and good sealing by virtue of the sealing fin. It is therefore able to achieve the stated objectives.

The device according to the invention can advantageously have the following characteristics:
The height of the sealing fin is greater than that of the anchoring fin. Any remaining space between the bar and the profile member can thus be easily filled by the sealing fin.
At least the anchoring fin can be made of a first material, and the sealing fin is made at least partially of a second material more flexible than the first material and is disposed so as to face at least one of the inner faces of the hollow portion of a profile member. The anchoring fins and the sealing fins thus have disparate functions, making it possible to optimize their technical characteristics according to the function to be performed.
The portion of the sealing fin made of the second material has a width that is between one and four times the width of the anchoring fin. The contact between the sealing fin and the inner face of the profile member is therefore broad enough to ensure effective sealing.
The sealing fin comprises at least one lateral rib which is made of the first material and the edge of which farthest from the bar is at least partially covered by at least one bead made of the second material. The lateral ribs and the anchoring fins can thus be produced during a single production step.
The lateral rib has a height that is less than that of the anchoring fin.
The bead defines at least two substantially parallel transverse lips separated by a groove facilitating the elastic deformation of the transverse lips.
The connector comprises a plurality of anchoring fins and a plurality of sealing fins distributed on both sides of each bar, the anchoring fins being provided between the sealing fins and the pad.
The connector comprises at least one longitudinal reinforcing rib carried by at least one of the bars and joining the pad to the anchoring fins and to the sealing fins, and arranged to stiffen the bar, the anchoring fins and the corresponding sealing fins.
For each bar, the portions of the sealing fins made of the second material are joined to one another, on both sides of the bar, by nets made of the second material and running along each lateral edge of the bar.
The pad has an opening passing through it and the nets are joined to one another by a core made of the second material and filling the opening.
The pair of first and second materials is selected from the group comprising at least the pairs polyamide/thermoplastic elastomers, polypropylene/PP, and ethylene propylene diene monomer (EPDM).

The invention also relates to a double-pane window including at least two substantially parallel glass panes separated by a frame formed of at least one profile member including at least two hollow portions joined together by a connector as previously described, the bars of which are inserted in the hollow portions of a profile member. At least one of the hollow portions of the profile member can include desiccant granules, and the sealing fin can be arranged to cooperate with the inner face of the hollow portion of a profile member and form a sealing barrier with respect to the granules.

In one form thereof, the present invention provides a connector for hollow portions of profile member(s), the connector including two longitudinal bars joined together by a pad and intended to be inserted respectively in the hollow portions of profile member(s), each bar being provided with at least one laterally-extending transverse anchoring fin arranged to cooperate with the inner face of the corresponding hollow portion of a profile member in order to mechanically attach the connector to the profile member, characterized in that each bar is also provided with at least one laterally-extending transverse sealing fin arranged to cooperate with the inner face of the hollow portion of the profile member to form a sealing barrier in the profile member.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a portion of a connector according to the invention;

FIG. 2 is a perspective view of a connector according to the invention; and

FIG. 3 is a perspective view in partial cutaway of a connector according to the invention, one of the bars of which is seated in a frame profile member for a double-pane window.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

The connector according to the invention is generally used to form a frame for a standard double-pane window (not shown). However, it can be used for any other suitable application. In a known manner, the double-pane window comprises at least two substantially parallel glass panes separated by a frame. This frame is formed by hollow profile members joined together by connectors according to the invention. The profile members can be hollow over their entire length or only at their free ends. To encompass these two configurations, the term that will be used herein is “hollow portions of profile members.” The frame can also be formed by a single profile member, which is bent at the corners, and the free ends of which are joined to each other by a connector according to the invention. This single profile member can also be hollow over its entire length or only in the region of its free ends. Regardless of the embodiment chosen, granules of desiccant material can be provided inside the hollow portions of profile members to absorb the moisture present in the gas. For this purpose, that face of the profile member which is oriented toward the inside of the frame is advantageously provided with small, mutually aligned perforations that allow the gas present between the glass panes to pass into the interior of the profile member. In a non-limiting manner, the description that follows focuses on a frame composed of a plurality of profile members connected to one another at the corners of the frame by connectors.

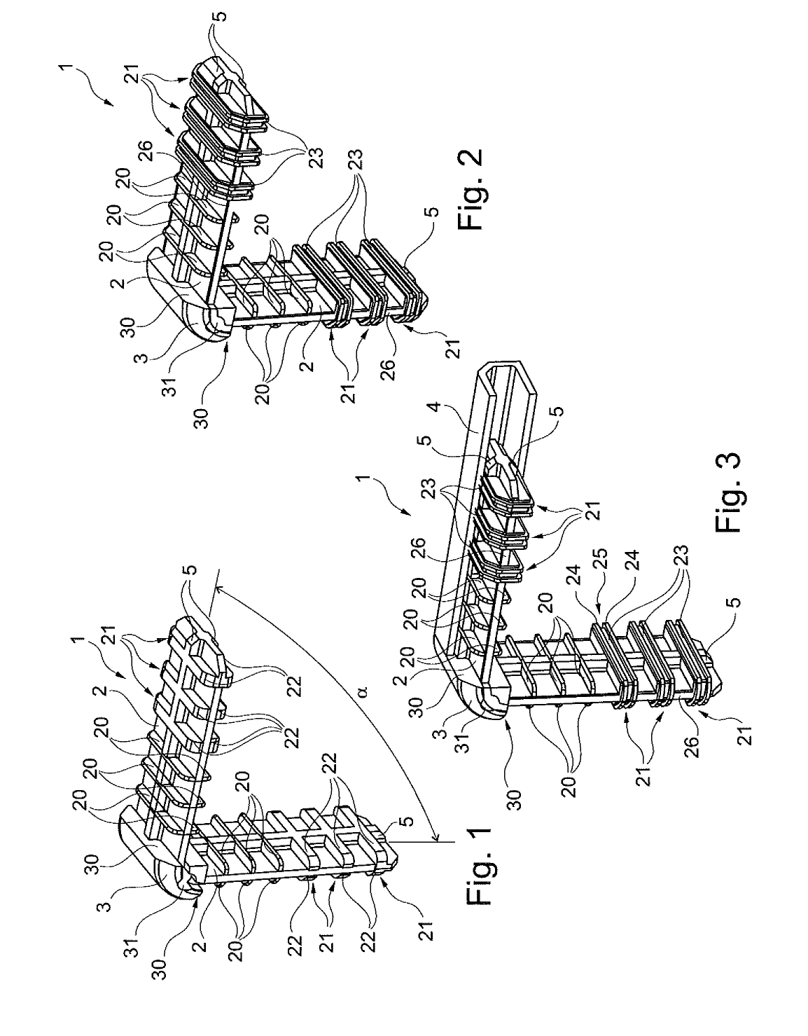

With reference to FIGS. 1 to 3, the connector 1 according to the invention comprises two longitudinal bars 2 intended to be seated in the free ends of the hollow portions of profile members 4, only one of which is depicted in FIG. 3. In this example, the bars 2 are each in the form of a substantially rectilinear plate. They are oriented so as to define between them an angle a of approximately 90° (illustrated schematically in FIG. 1) and are joined together by a corner pad 3. In this example, the outer face of the pad 3 is curved to form a gentle, non-aggressive angle. The pad 3 thus has the shape of a quarter-circle whose straight sides have dimensions greater than the thickness of the bars 2. The pad 3 thus delimits bearing surfaces 30 adapted to receive the load from the ends of the hollow portions of profile members 4 when the bars are fitted into these hollow portions of profile members 4 (see FIG. 3). The bars 2 and the pad 3 are made of a first material, designated as rigid, for example a plastic such as polypropylene, polyamide. They advantageously thus form a single piece.

Each bar 2 comprises transverse anchoring fins 20 extending laterally from each face of the bar 2. These anchoring fins 20 are arranged substantially perpendicular to each face of the corresponding bar 2 and substantially perpendicular to the longitudinal axis of each bar 2. These anchoring fins 20 are made of the first material, which is designated as rigid, and advantageously form a single piece with the bars 2 and the pad 3. The anchoring fins 20 have dimensions adapted to the respective interiors of the hollow portions of the profile members 4 for which they are intended. These dimensions are selected to permit the forcible insertion of the bar 2 into the hollow portions of the profile member 4 and lock the connector 1 in the profile member 4, thus preventing it from inadvertently coming out. In the example illustrated, each bar 2 comprises six anchoring fins 20 distributed in two groups of three anchoring fins 20 each, aligned two by two on each side of the bar 2. The bar 2 can, of course, have a larger number of anchoring fins 20 and/or anchoring fins 20 that are offset from one face of the bar 2 to the other.

Each bar 2 also comprises sealing fins 21. Referring in particular to FIG. 1, each sealing fin 21 is formed by a transverse lateral rib 22 extending laterally from each face of the bar 2 and made of a rigid material, for example the first material. The lateral rib 22 has a comparable profile to that of the anchoring fins 20, but with a smaller height and a larger width. The lateral ribs 22 advantageously form a single piece with the bars 2, the pad 3 and the anchoring fins 20. The lateral ribs 22 are arranged substantially perpendicular to each face of the corresponding bar 2 and substantially perpendicular to the longitudinal axis of each bar 2. They are therefore substantially parallel to the anchoring fins 20. The lateral ribs 22 are disposed beyond the anchoring fins 20 from the standpoint of the pad 3. The anchoring fins 20 are therefore located between the pad 3 and the lateral ribs 22. In this example, the anchoring fins 20 and the lateral ribs 22 are disposed at regular intervals. The lateral ribs 22 are provided to be six in number, distributed into two groups of three lateral ribs 22 each, aligned two by two on each side of the bar 2, and/or lateral ribs 22 that are offset from one face of the bar 2 to the other. The bar 2 can, of course, have a larger number of lateral ribs 22. The bearing surfaces 30 of each pad 3, as well as the sealing fins 21 and the lateral ribs 22 disposed on the corresponding face of the bar 2, are joined together by a longitudinal reinforcing rib 5 that serves to stiffen them. This reinforcing rib 5 is, for example, made of the first material, and has a height substantially similar to that of the lateral ribs 22.

Referring in particular to FIGS. 2 and 3, each lateral rib 22 is covered by a bead 23 made of a second material, designated as soft. The term “second, soft material” is understood to mean a less rigid, more flexible material than the first material, capable of deforming elastically when the bar 2 is forcibly inserted in the free end of the hollow portion of a profile member 4, so as to fill all the remaining space between each lateral rib 22 and the inner face of that hollow portion of a profile member 4. To promote this deformation, the height formed by the bead 23 carried by the lateral rib 22 is such that the total height of the sealing fins 23 is greater than those of the anchoring fins 20. Thus, the bead 23 of the sealing fin 21 cooperates with the inner face of the hollow portion of a profile member 4 to prevent any granules (not shown) disposed in the profile member 4, particularly desiccant granules, from escaping therefrom. To ensure good leak-tightness, the bead 23 has, for example, a width that is between one and four times the width of the anchoring fin 20. In an advantageous manner, the bead 23 defines two substantially parallel transverse lips 24, shown in detail in FIG. 3, which are separated by a groove 25 facilitating the elastic deformation of the transverse lips 24. Each bead 23 completely covers that edge of the lateral rib 22 which is farthest from the bar 2, as well as the faces and flanks of the lateral ribs 22 on which it is disposed. Leak-tightness is thus achieved over the entire periphery of the sealing fin 21. The flexibility of the second material also makes it possible to limit the impact of thermal dispersion. The beads 23 are further joined to one another by nets 26 running along the lateral edges of the bars 2. In the example illustrated, the pad 3 has extending through it an opening filled with a core 31 formed of the second material and joined to the nets 26. Thus, the nets 26 of a first bar 2 are joined to the nets 26 of the second bar 2. This particular design permits easy manufacture of the connector 1, which can be done by:
injecting the bars 2, the pad 3, the anchoring fins 21 and the lateral ribs 22 with a first material to form the rigid framework of the connector 1,
overmolding the second material onto the first material to form the bead 23, the soft nets 26 and the core 31; this overmolding can be performed with a rotary mold.

The core 31 and the nets 26 make it possible, in a first overmolding step, to feed the mold cavities intended to form all the beads 23. The core 31 thus serves as a transfer channel for transferring the second material from one side of the bar 2 to the other during the overmolding step. In the example shown, each bar 2 has three sealing fins 21.

The first and second materials are chosen for their compatibility, to facilitate chemical bonding between them. Thus, the pair of first and second materials used is preferably selected from polyamide/thermoplastic elastomers, polypropylene/PP, and ethylene propylene diene monomer (EPDM).

According to an embodiment not shown, the bars can be bent into a curve to receive profile members having a complementary curvature. The connector can also comprise a straight bar and a curved bar.

According to yet another embodiment that is not shown, the angle a formed between the bars can be different from the example, and range from 0 to 180°. Thus, in the case of an angle a of 180°, the connector is provided with bars disposed in each other's prolongation, making it possible to connect two profile members in alignment with each other. In that case, the pad separating the bars is an alignment pad rather than a corner pad.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-14. (canceled)

15. A connector for use in connecting hollow portions of profile members, said connector comprising:
two longitudinal bars joined together by a pad, each bar including at least one laterally-extending transverse anchoring fin arranged to cooperate with an inner face of a hollow portion of a profile member to mechanically attach said connector to the profile member, and at least one laterally-extending transverse sealing fin arranged to cooperate with the inner face of the hollow portion of the profile member to form a sealing barrier in the profile member.

16. The connector of claim 15, wherein a height of said sealing fin is greater than a height of said anchoring fin.

17. The connector of claim 15, wherein at least said anchoring fin is made of a first material and said sealing fin is made at least partially of a second material more flexible than said first material and is disposed to face an inner face of the hollow portion of a profile member.

18. The connector of claim 17, wherein said portion of said sealing fin made of said second material has a width that is between one and four times a width of said anchoring fin.

19. The connector of claim 17, wherein said sealing fin includes at least one lateral rib made of said first material and including an edge at least partially covered by at least one bead made of said second material.

20. The connector of claim 19, wherein said lateral rib has a height that is less than a height of said anchoring fin.

21. The connector of claim 19, wherein said bead defines at least two substantially parallel transverse lips separated by a groove facilitating the elastic deformation of said transverse lips.

22. The connector of claim 15, further comprising a plurality of anchoring fins and a plurality of sealing fins distributed on both sides of said bar, said anchoring fins being disposed between said sealing fins and said pad.

23. The connector of claim 22, further comprising at least one longitudinal reinforcing rib carried by at least one of said bars and joining said pad to said anchoring fins and to said sealing fins, and arranged to stiffen said bar, said anchoring fins and the corresponding said sealing fins.

24. The connector of claim 17, wherein for each bar, said portions of said sealing fins made of said second material are joined to one another, on both sides of said bar, by nets made of said second material and extending along each lateral side of said bar.

25. The connector of claim 22, wherein for each bar, said portions of said sealing fins made of said second material are joined to one another, on both sides of said bar, by nets made of said second material and extending along each lateral side of said bar.

26. The connector of claim 24, wherein said pad includes an opening in which said nets are joined together by a core made of said second material and filling said opening.

27. The connector of claim 17, wherein said pair of first and second materials is selected from the group consisting of polyamides, thermoplastic elastomers, polypropylene, and EPDM.

28. A double-pane window comprising at least two substantially parallel glass panes separated by a frame formed of at least one profile member including at least two hollow portions, said hollow portions of said profile member joined together by said connector of claim 15, said bars of said connector inserted in said hollow portions of said profile member.

29. The double-pane window according to claim 28, wherein at least one of said hollow portions of said profile member includes desiccant granules and said sealing fin is arranged to cooperate with an inner face of said hollow portion of said profile member and form a sealing barrier with respect to said granules.
